(19) United States
(12) Patent Application Publication
(10) Pub. No.: US 2026/0078835 A1
(43) Pub. Date: Mar. 19, 2026

(54) PRECISION ELECTRIC MOTOR BASED MECHATRONIC ACTUATED PRESSURE CONTROL VALVE

(71) Applicant: Sunstream Scientific, Inc., Chicago, IL (US)

(72) Inventor: Michael Kenneth Kriegsmann, Chicago, IL (US)

(21) Appl. No.: 19/330,325

(22) Filed: Sep. 16, 2025

Related U.S. Application Data
(60) Provisional application No. 63/694,995, filed on Sep. 16, 2024.

(51) Int. Cl. F16K 31/04; H02K 1/14; H02K 1/24; H02K 5/10; H02K 5/16; H02K 7/06

(52) U.S. Cl. CPC F16K 31/043; H02K 1/146; H02K 1/246; H02K 5/10; H02K 5/161; H02K 7/06; H02K 2201/03

(57) ABSTRACT

Disclosed herein are methods and systems of electromechanical actuation applied to robust electrohydraulic pressure control. The system includes an electric motor optimized for electrohydraulic systems and characterized by features that provide for the conversion of rotational to linear motion in a compact package. A valve body includes a high-pressure port, a low-pressure port, and a variable working pressure port. A valve spool is disposed within the valve body to direct oil flow into and out of a working volume, wherein the motive force to operate the valve spool is provided by an integrated electric motor and mechatronic assembly that eliminates conventional solenoid limitations while achieving superior dynamic response and contamination resistance.

### CROSS REFERENCE TO RELATED APPLICATIONS

This application claims the benefit of U.S. Provisional Application No. 63/694,995, filed on Sep. 16, 2024, and entitled “ELECTROHYDRAULIC PRESSURE CONTROL VALVE with PRECISION ELECTRIC MOTOR BASED MECHATRONIC DRIVE,” which is hereby incorporated by reference herein in its entirety.

### REFERENCE REGARDING FEDERALLY SPONSORED RESEARCH OR DEVELOPMENT

Not applicable

### SEQUENTIAL LISTING

Not applicable

### BACKGROUND OF THE DISCLOSURE

### 1. Field of the Disclosure

The present disclosure relates to electric motor based mechatronic devices optimized to actuate electrohydraulic valves, and more specifically pressure control valves.

### 2. Description of the Background of the Disclosure

In many fluid power systems, it is desirable to produce work by controlling oil pressure in a cavity or variable volume, or to counterbalance loads, or regulate flow, or any number of functions. Electrohydraulic pressure-reducing relieving valves are the leading economical technology for these purposes, and commercially available from a broad number of suppliers in a broad selection of sizes and configurations. However, these valves are prone to poor response due to poor damping, delay in feedback signaling, and inertia dominated dynamics.

Conventional single-stage electrohydraulic pressure control valves comprise a linear solenoid as the energizing motive element that is directly coupled to the fluid metering element (or spool). Due in part to the high mass of the solenoid armature, this arrangement yields a low bandwidth control element with poor damping characteristics. Further, due to the motive force and stroke limitations of the linear solenoid, these electrohydraulic pressure control valves are sensitive to fluid contamination and have poor flow gain resolution.

There has been limited development and production of electrohydraulic valves that are energized by rotary stepper or servo motors. Both architectures have dynamic and packaging shortcomings-especially in the linear space required for integration. In a conventional electric motor arrangement, wherein the rotor rigidly receives a motor shaft which defines the axis of rotation, and wherein the DE and NDE end bells retain radial bearings that receive opposite ends of the motor shaft, and wherein each end bell is aligned to opposite ends of the stator by centering features integral to these elements, there is an unavoidable margin of misalignment between the stator and rotor caused by multiple stack up tolerances that results in imbalanced magnetic and inertial forces and limits motor performance.

### SUMMARY OF THE DISCLOSURE

The invention can be generally categorized as an electric motor optimized to actuate a broad class of electrohydraulic control valves and specifically with a mechatronic drive configured to couple to a pressure reducing-relieving valve comprising a valve body with a high pressure (supply) port, a low pressure (tank) port, and a variable pressure work port; a valve spool disposed within a valve body to direct oil flow into and out of a working volume; and an electromechanical subassembly to generate an elastic (spring) force to provide the energizing force input to the valve spool. This arrangement eliminates the solenoid armature as an element in the moveable chain yielding a control element with significantly higher bandwidth than conventional electrohydraulic valves. Operationally, the electromotive force generated by the electromechanical subassembly, which converts rotary motion to linear motion, to generate a working pressure through a hydraulic circuit.

The electromechanical subassembly involves a novel arrangement of electric motor elements that cooperatively convert torque into linear motion through a mechanical chain comprising a motor body, stator, rotor, power screw, power nut, and energizing spring. A novel interrupted journal bearing arrangement provides for precise alignment of stator and rotor axes, eliminates the conventional rotor shaft, and allows for a space efficient internally nested packaging of power nut, power screw, and energizing spring components. Unlike conventional motors where bearing and magnetic elements are separately manufactured and assembled, the present invention integrates these elements into precision composite bodies, eliminating tolerance accumulation and achieving substantially balanced magnetic forces during operation. The power screw and nut absorb the axial force of the energizing spring in this arrangement.

It is the primary objective of the present invention to provide an energizing motive strategy that is economical and compact, with superior control, displacement, and force characteristics in comparison to previous actuators employed in electrohydraulic valves.

It is another object of the invention to provide a pressure control valve with superior dynamic and flow resolution characteristics, and superior robustness to fluid contamination.

It is yet another object of the invention to demonstrate a means to precisely tune the damping characteristics of the valve spool. In pursuit of this objective, high pressure fluid is delivered to a pair of opposed dashpots. It is desirable to utilize high pressure fluid for damping, as the stiffness of hydraulic fluid increases with increasing pressure due to the entrained air common to hydraulic systems.

### BRIEF DESCRIPTION OF THE DRAWINGS

FIG. 1 is a cross-sectional view of an electrohydraulic pressure control valve energized by a electromechanical device and comprising tunable damping features, wherein the electromechanical device shown comprises a novel electric motor.

FIG. 2 is a detailed illustration of a power nut, an element of the electromechanical device, with anti-rotation features.

FIG. 3 is a detailed illustration of the screw shaft, another element of the mechatronic apparatus, that operatively couples with the power nut.

FIG. 4 is a first cross-section of the electrohydraulic pressure control valve of FIG. 1, taken through A-A, and illustrating electric motor features of the mechatronic apparatus.

FIG. 5 is a second cross-section of the electrohydraulic pressure control valve of FIG. 1, taken through B-B, and further illustrating electric motor features of the mechatronic apparatus.

FIG. 6 is the electrohydraulic pressure control valve of FIG. 1 illustrated in an energized condition with the valve spool partially biased.

FIG. 7 is the electrohydraulic pressure control valve of FIG. 1 illustrated in a de-energized condition with an alternative embodiment of damping elements.

FIG. 8 is an alternative embodiment of the electrohydraulic pressure control valve of FIG. 1.

FIG. 9 is a detailed illustration of rotor, end bell, and thrust bearing elements.

FIG. 10 is a detailed illustration of elements that provide for rotational slippage between power nut and energizing spring.

FIGS. 11a-c illustrate the effects of misalignment between stator and rotor axes.

FIG. 12 illustrates the electrohydraulic pressure control valve with an alternative embodiment of the electric motor assembly.

### DETAILED DESCRIPTION OF THE DRAWINGS

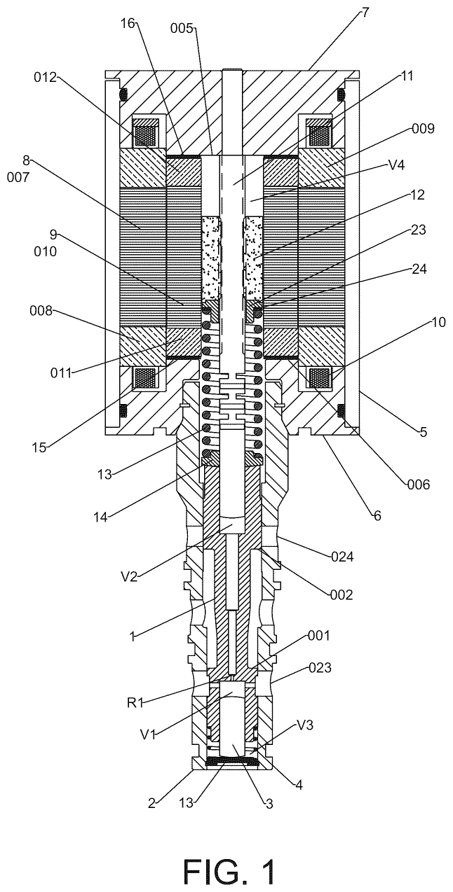

FIG. 1 illustrates an electrohydraulic pressure control valve assembly, in which the flow of pressurized hydraulic fluid through the valve is directed by a valve spool 1, slidably disposed in and received by valve body 2, and energized by a spring motive force generated by a novel electric motor and power screw drive arrangement.

An electric motor subassembly comprises a motor case 5, a drive end (DE) end bell 6, a non-drive end (NDE) end bell 7, a stator subassembly 8 with a plurality of poles received within motor case 5 and rigidly disposed between end bell 6 and end bell 7, a rotor subassembly 9 received within stator 8 and movably disposed, and a plurality of coil windings 10 operatively coupled to stator 8 by assembly methods known to the art; these cooperatively defining a magnetic circuit which generates a working electromotive torque when coil windings 10 are properly energized. Sealing methods (illustrated without numbers) are provided between motor case 5 and end bell 6, and between motor case 5 and end bell 7 and configured to prevent unintended egress of hydraulic oil from the motor cavity and ensure lubrication and thermal stability of the components within.

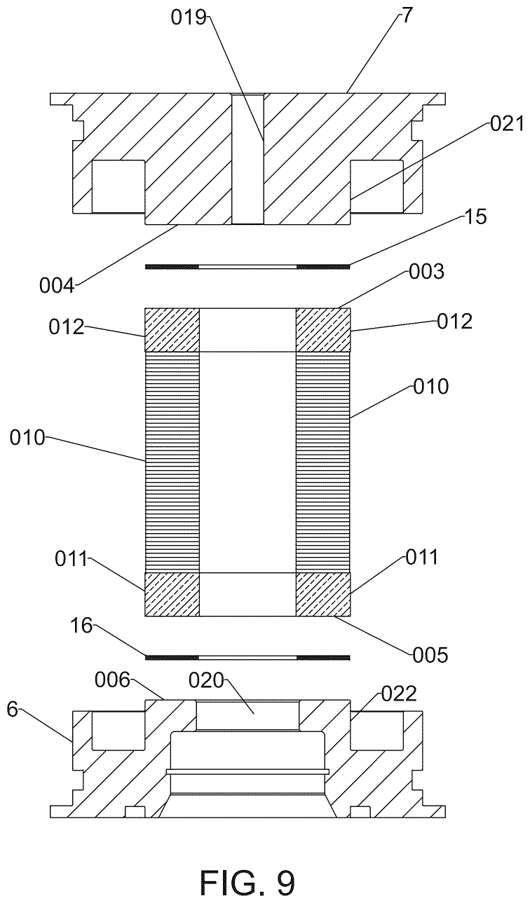

This subassembly further comprises a screw shaft 11 received by bore feature 019 in end bell 7 and fixed against rotation, power nut 12 received by rotor 9 and slidably disposed, energizing spring 13 received in part by an internal bore feature of rotor 9 and operatively coupled to the power nut 12, and a spring pilot 14 that operatively couples energizing spring 13 to valve spool 1. A first thrust bearing 15 is operatively disposed between rotor planar feature 003 and NDE end bell planar feature 004, and free to rotate. A second thrust bearing 16 is operatively disposed between rotor planar feature 005 and DE end bell planar feature 006, and free to rotate. Refer to FIG. 9 for details on thrust bearings.

Refer to FIG. 9 for additional details of features integral to the DE end bell and the NDE end bell. DE end bell opening 020 permits power transmission from rotor to an external apparatus and provides for a fluid communication path enabling the exchange of hydraulic oil in the motor cavity with an external source of fluid. DE end bell alignment boss 022 couples to stator feature 008 and is configured to align the axes of the stator and opening 020. NDE end bell alignment boss 021 couples to stator feature 009 and is configured to align the axes of the stator and NDE end bell feature 019.

Rotor 9 comprises a plurality of ferromagnetic laminations 010, a first non-ferromagnetic rotor bearing feature 011, and a second non-ferromagnetic rotor bearing feature 012, wherein said ferromagnetic laminations 010 are situated between the first rotor bearing feature 011 and the second rotor bearing feature 012, and wherein the individual elements are collectively affixed into a cohesive, composite body by methods known to the art. A secondary manufacturing process, such as between centers or such as end-feed centerless grinding, will be performed on the rotor such that the OD of features 011 and 012 are collectively formed with precise size and cylindricity and precisely coaxial with 010. This secondary process will further precisely control the size and cylindricity of OD features of 010. FIG. 9 better illustrates the bearing features described in [0015] and [0017].

Stator 8 comprises a plurality of ferromagnetic laminations 007, a first non-ferromagnetic stator bearing feature 008, and a second non-ferromagnetic stator bearing feature 009, wherein said ferromagnetic laminations 007 are situated between the first stator bearing feature 008 and the second stator bearing feature 009, and wherein the individual elements are collectively affixed into a cohesive, composite body by methods known to the art. A secondary manufacturing process such as honing or ID grinding will be performed on the stator assembly such that the ID of features 007, 008, and 009 are precisely coaxial and collectively formed with precise size and cylindricity.

This arrangement of stator bearings 008 and 009, rotor bearings 011 and 012, planar surfaces 003, 004, 005, and 006, and thrust bearings 15 and 16 is configured to bound axial and radial translation of the rotor 9, while allowing said rotor 9 to rotate freely and bidirectionally with respect to stator 8. By directly integrating radial bearing surfaces and ferromagnetic steel laminations into a precision cohesive, composite stator body 8, and separately into a precision cohesive, composite rotor body 9, stack up tolerances may be eliminated. Consequently, a small radial gap between ID and OD bearings can be maintained, and a greatly improved axial alignment can be achieved. Further, the outer cylindrical envelope of rotor lamination stack 010 is smaller than the shared bearing diameters 011 and 012 thus producing an air gap between the ferromagnetic laminations 007 of the stator and the ferromagnetic laminations 010 of the rotor. By targeting a nominal magnetic air gap distance substantially larger than the nominal radial bearing gap distance, such as a ratio of 10:1, a near constant air gap can be achieved during rotor operation, leading to balanced magnetic and inertial forces.

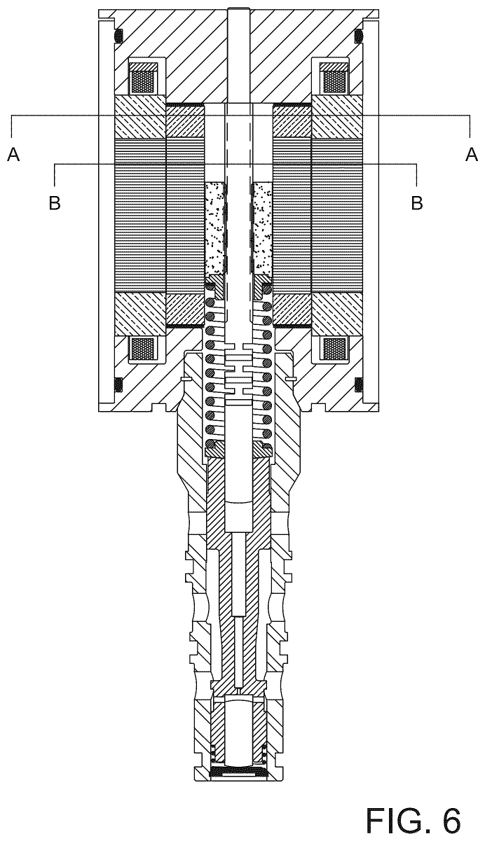

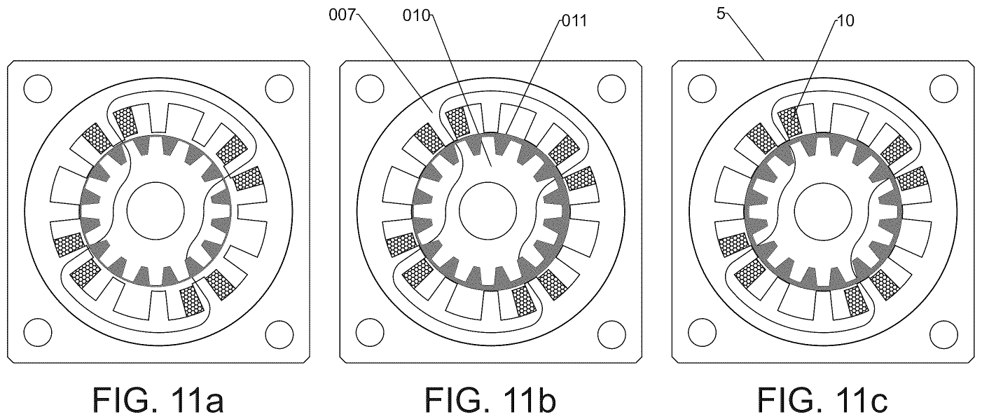

For greater clarity, refer to the three illustrations in FIG. 11 derived from Section B-B of FIG. 6. For illustrative purposes only, the cylindrical envelope of rotor lamination stack 010 is shown to be much smaller than the diameter of rotor bearing features 011 and 012. For further illustrative purposes, a single winding of a 3-phase 12 stator pole Switched Reluctance Motor (SRM) architecture is displayed to convey the electromagnetic attraction between the stator and rotor salient poles based on the reluctance principle. The magnetic forces between salient poles have tangential and radial components with respect to the rotor axis of rotation, wherein the tangential forces produce useful torque, and the radial components, if not properly balanced, introduce undesirable friction and vibration. FIG. 11a illustrates an arrangement wherein the rotor laminations 010 are in perfect axial alignment with bearing features 011 and 012, but wherein the radial gap between said bearing features 011 and 012 and stator bearing features 008 and 009 are excessive. This arrangement will lead to axial eccentricity and cause asymmetric air gaps between opposing salient poles during operation, and thus imbalanced magnetic forces, with the salient poles having a smaller air gap exerting more attraction than the opposing salient poles having a larger air gap. FIG. 11b illustrates an arrangement where the radial gap between said bearing features 011 and 012 and stator bearing features 008 and 009 are precise, but wherein the rotor laminations 010 are axially mis-aligned with bearing features 011 and 012. This arrangement will also lead to an asymmetric air gap between salient poles during operation, and thus imbalanced magnetic forces. FIG. 11c illustrates an arrangement where the radial gap between said bearing features 011 and 012 and stator bearing features 008 and 009 are precise, and wherein the rotor laminations 010 are in perfect alignment with bearing features 011 and 012. This arrangement achieves equal air gaps between all opposing salient poles and thus balances magnetic forces thereby addressing the objective of the design herein described.

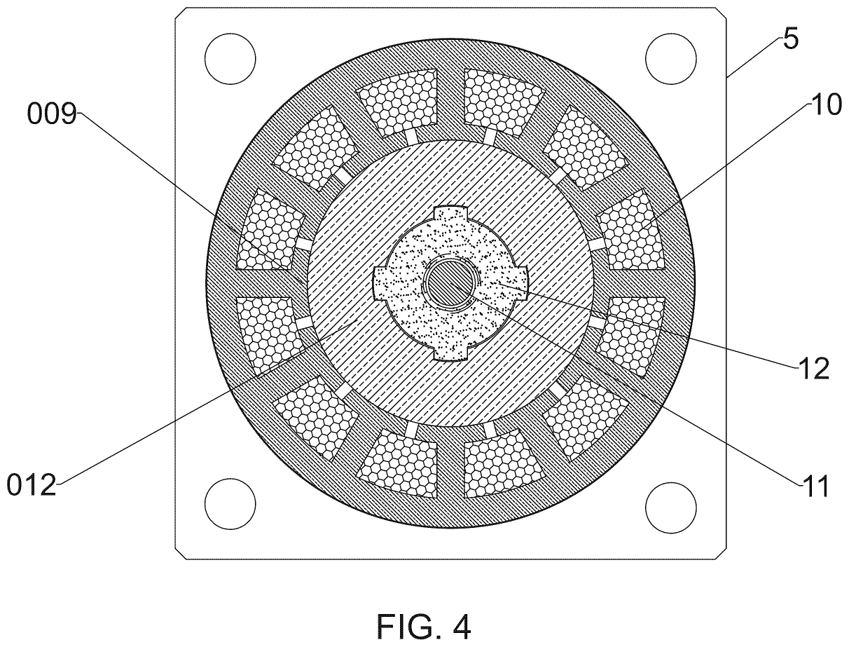

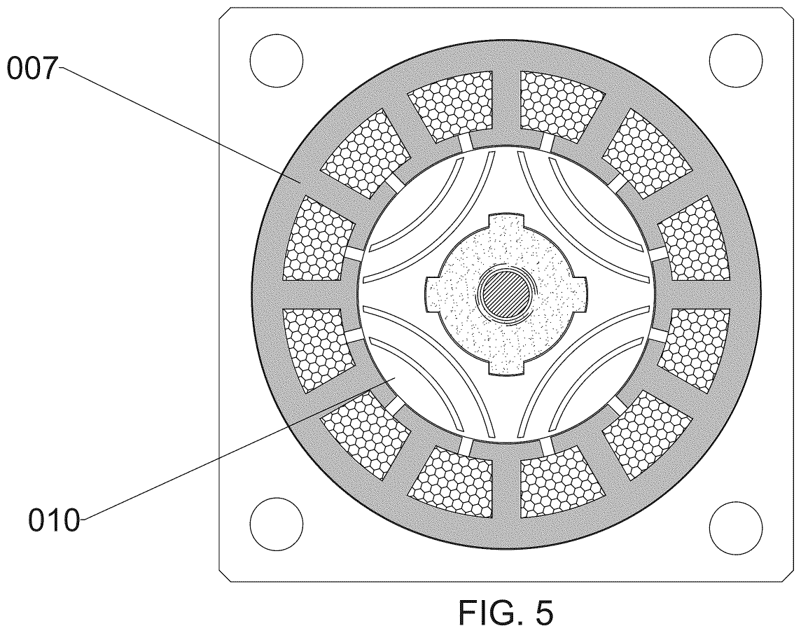

Refer to FIG. 4 Section A-A through stator bearing 009 and rotor bearing 010 and FIG. 5 Section B-B through stator lamination 007 and rotor lamination 010. Bearing surfaces must be nonferromagnetic for proper operation, and optimally non-conductive, wear resistant, low friction, and with thermal coefficient properties nearly equivalent to laminations 007 and 010. Bearings 008, 009, 011 and 012 may be composed of a single, solid element or a stack of laminations. The profile of stator bearings 008 and 009 match that of said stator laminations so as to permit assembly of coil windings 10.

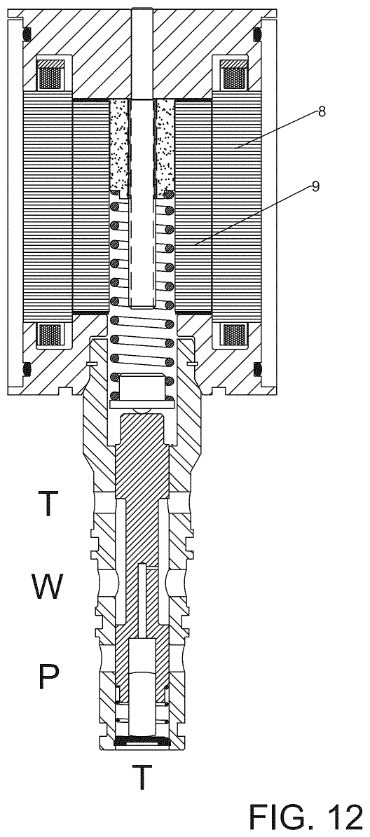

An alternative embodiment illustrated in FIG. 12 forgoes the first arrangement of stator and rotor bearings, in exchange for a non-magnetic, non-conductive, high wear material adherently deposited to the outer surface of rotor 9 laminations and to the inner cylindrical surfaces of said stator 8 laminations. These dielectric layers, deposited to sufficient thickness and finished by secondary processes such as honing and grinding to precision tolerances, provide for a plain bearing arrangement that precisely aligns the rotor and stator axes with a radial gap less than 0.001″, wherein the combined thickness of the dielectric layers on ID and OD surfaces maintains a constant annular air gap between said stator inner cylindrical surfaces and outer rotor diameter during operation. For example, it may be optimal to target a nominal total dielectric deposit thickness of 0.005″ while targeting a nominal mechanical radial gap of 0.0005″.

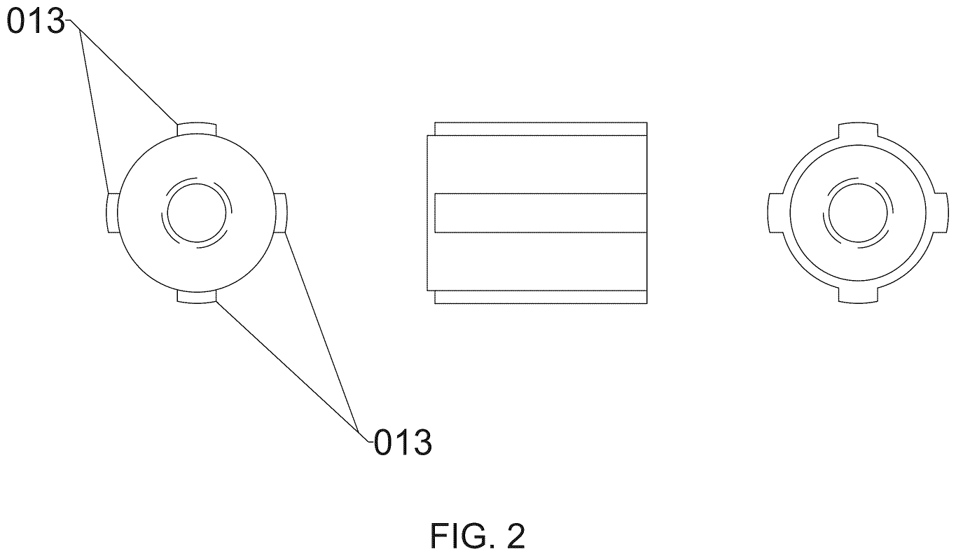

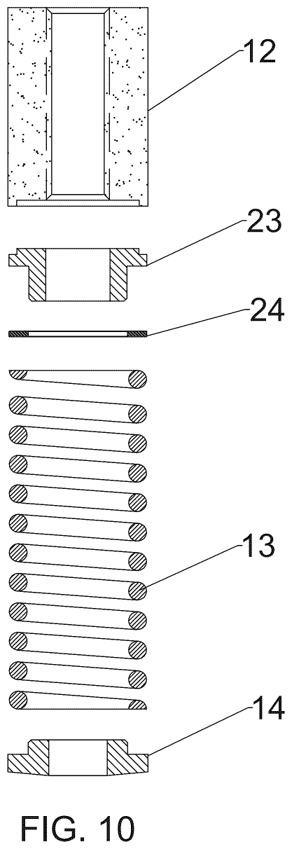

Refer to FIG. 2 for a detailed illustration of power nut 12 that is received by rotor 9. An array of circumferential anti-rotation features 013 received by mating geometries in the bore of rotor 9 prevents relative rotational motion between the rotor and nut, while allowing free axial translation of the power nut relative to the rotor 9. As rotor 9 is energized by an electromagnetic field, the torque created causes the rotor and the power nut to rotate in unison and the power nut to slide axially with respect to rotor 9 depending on the direction of rotation. Methods are conceived to minimize the friction between nut 12 and rotor 9 so as to limit axial loads imparted on rotor 9 during operation. ID threads of nut 12 engaged with threads of screw shaft 11 convert torque into a linear force that imparts axial motion on power nut 12 and governs compression of energizing spring 13. Power nut 12 is operatively coupled to valve spool 1 through a mechanical chain comprising an energizing spring 13, nut pilot 23, thrust bearing 24, and spring pilot 14. As power nut 12 rotates with the rotor and translates along screw shaft 11, the compression of energizing spring 13 is increased or relaxed depending on the direction of travel. The nut pilot 23 and thrust bearing 24 provide for rotational slippage between power nut 12 and energizing spring 13. A motion controller (not shown) is contemplated to control axial displacement of the power nut 12 by precisely controlling the total angle of rotation of the rotor body 9. In this manner, torque generated by the electric motor is converted into a linear force input to valve spool 1. The high mechanical advantage of this mechatronic arrangement permits substantially higher energizing forces than conventional solenoids and is thus more robust to fluid contamination. By design, the axial spring compression load is absorbed by the power nut 12 and screw shaft 11, but not rotor 9. FIG. 10 provides details of these elements.

The valve body 2, into which valve spool 1 is received and slidably disposed, is defined in part by a plurality of coaxial inner and external cylindrical features and comprises high pressure supply port P, low pressure tank ports T, and working pressure port W. Multiple methods are conceived to introduce oil from T to motor volume V4. However, additional embodiments are contemplated that introduce oil from P or W into motor volume V4. The location of these ports is most clearly illustrated in FIG. 12.

The valve spool 1 comprises cylindrical lands 001 and 002, which act cooperatively as a bearing surface for guiding axial movement, and where the diameter of 002 is larger than the diameter of 001. The valve body 2 comprises a plurality of circumferentially arranged windows in groups 023 and 024 that provide fluid transmission paths between port P and port W, and port W and port T respectively, and regulated by displacement of lands 001 and 002. The diametral difference between lands 001 and 002 allows for working pressure W acting on these areas to create a force bias in the direction of the motor assembly.

A spool bias pin 3 received in part by a first cylindrical cavity in spool 1 isolates high pressure oil in volume V1 from low pressure volume V3. Oil is communicated between damping oil volume V1 and supply port P via passages formed within valve spool 1. A terminal cylindrical feature 017 of screw shaft 11 is received by a second cylindrical cavity in the spool, opposite of the first cylindrical cavity, and isolates a spool damping volume V2 from low pressure volume V4. Screw shaft 11 has an additional section 016 with intermittent slits or cuts configured to add bending compliance while maintaining axial and torsional stiffness. These features provide for a small amount of axial misalignment between screw shaft and spool. Oil is communicated between damping oil volumes V1 and V2 via restriction R1, formed within the valve spool. The cylindrical cavities partially defining V1 and V2 are of equal diameter, so that the static pressure bias forces created by these damping volumes are cancelled, and the net static force is zero.

A valve spring 4, deployed within volume V3 and encircling bias pin 3, ensures a reliable valve spool bias. End plug 17 is received by open annulus of valve body 2 and rigidly disposed, serving as a stop for bias pin 3 and valve spring 4. End plug 17 further vented to allow communication of oil pressure in V3 to tank pressure T.

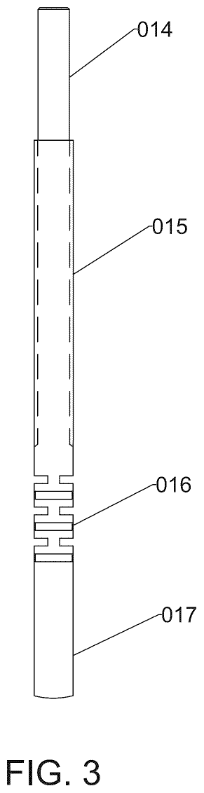

Refer to FIG. 3 for a detailed illustration of power screw shaft 11. Screw shaft 11 comprises first feature 014 to be received by end bell 7 and fixed against rotation, screw feature 015 that operatively couples with the power nut 12 to generate linear motion, compliant feature 016 to provide for axial misalignment between the screw shaft and valve spool 1, and second cylindrical feature 017 to be received by cylindrical cavity in valve spool 1 associated with volume V2 and damping function.

Refer to FIG. 4 for a detailed illustration of cross-section A-A, with reference to FIG. 6 for longitudinal cross-section location. This cross-section is taken through stator bearing feature 009 and rotor bearing feature 012.

Refer to FIG. 5 for a detailed illustration of cross-section B-B, with reference to FIG. 6 for longitudinal cross-section location. This cross-section is taken through stator lamination feature 007 and rotor lamination feature 010. The rotor, as it is illustrated herein, defines a synchronous reluctance (SynRM) type architecture. However, other rotor architectures are contemplated such as switched reluctance (SRM) or permanent magnet (PM) architectures.

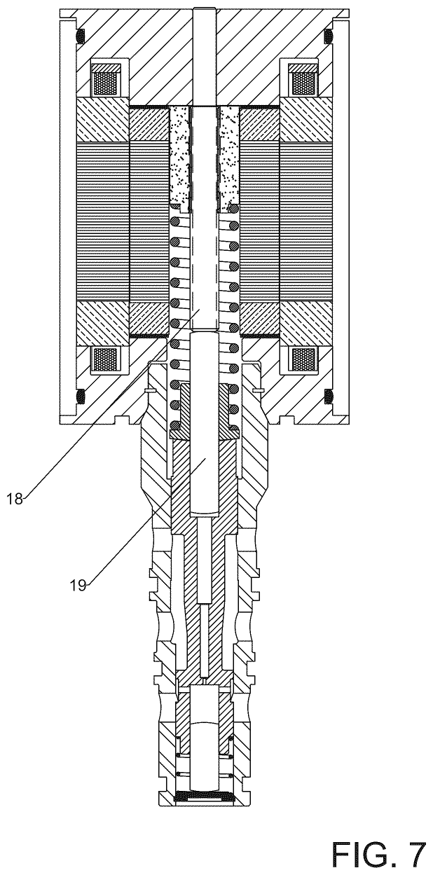

Refer to FIG. 7 for an alternative embodiment of screw shaft 18 that separates features 016 and 017 and substituting a second bias pin 19 that is received by a second cylindrical cavity in valve spool 1. Bias pin 19 replicates the function of feature 017 of screw shaft 11 of FIG. 1 and FIG. 6. Pressure in damping volume V2 biases pin 19 against screw shaft 18. This arrangement eliminates the requirement for alignment feature 016 of screw shaft 11.

FIG. 7 further illustrates the power nut in the fully retracted condition, thus best demonstrating longitudinal space saved by this architecture wherein the power transmission elements, including the energizing spring, are operatively received by the rotor thru passage feature.

In the neutral position of the valve spool 1, as shown in FIG. 1, land 002 restricts oil flow between working port W and low-pressure port T, and land 001 restricts oil flow between working port W and high-pressure port P. Working pressure W is defined by a function comprising high pressure P and low-pressure T and coefficients K_{IN}, defined by the transmissibility of oil between port W and port T, and K_{OUT} defined by the transmissibility of oil between port W and port P.

$${Pressure}_{W} = \frac{{K}_{IN}^{2} P + {K}_{OUT}^{2} T}{{K}_{IN}^{2} + {K}_{OUT}^{2}}$$

When K_{IN}=K_{OUT}, pressure W=0.5*(P+T). However, when the working volume W is static, small deviations in valve spool position from neutral result in large changes in the ratio between K_{IN} and K_{OUT} and thus correspondingly large changes in working pressure W.

FIG. 1 illustrates the energized power nut translated toward valve body 2 converting electromotive energy through power nut 12 to valve spool 1 by mechanical means of compressing energizing spring 13. When the system is in equilibrium, the spring force transferred mechanically to the valve spool is described as:

$${F}_{input} = {k}_{e \cdot spring} ( Δ {x}_{power \cdot nut} - Δ {x}_{valve \cdot spool} )$$

Where Fᵢₙₚᵤₜ is the input force of the energizing spring, k_{e.spring} is the rate of the energizing spring, Δx_{power.net} is the displacement of the power nut, and Δx_{valve.spool} is the displacement of the valve spool.

Valve spool 1 reaches equilibrium when energizing spring force driving the valve spool is balanced by the working pressure W imparted upon the annular feedback area of the valve spool (created by differential diameters of lands 001 and 002), and force exerted by valve spring 4. Note that fluid pressure forces in spool bias volumes V1 and V2 are equal in opposite directions and thus offset.

$${F}_{input} - {F}_{v \cdot spring} = {P}_{working} ( {Area}_{002} - {Area}_{001} )$$

A programmable electronic controller is contemplated to regulate the electric signal to motor windings 10. The relationship between desired work port W pressure and valve coefficients, defined in [0033], enables an electronic controller to calculate an estimate of the valve spool position necessary to generate said pressure. By making appropriate substitutions from the equation defined in [0036], the controller can determine the position of power nut 12 necessary to achieve the desired work port pressure.

$$Δ {x}_{power \cdot nut} = {L}_{s} {θ}_{m} = \frac{{P}_{working} ( {Area}_{002} - {Area}_{001} ) + {F}_{v \cdot spring}}{{k}_{e \cdot spring}} + Δ {x}_{valve \cdot spool}$$

The displacement of the power nut is the product of the rotational displacement of rotor 9 multiplied by the lead of screw 11. Thus, by controlling the rotational position of the rotor, work port pressure can be regulated. A motion controller is contemplated to regulate the position of the power nut by driving the rotor 9 to a desired angle of rotation via coordinated energization of the coil windings. It is further contemplated that rotor angle be measured via sensorless algorithms, but other methods to sense rotor angle are available. As pressure gain is typically high in hydraulic systems, valve spool 1 typically reaches an equilibrium at its centered position.

Movement of valve spool 1 in the direction away from the motor causes spool bias volume V1 to be contracted, and spool bias V2 to be expanded. Oil in said contracting volume is forced through restriction R1 into expanding volume V2 in order to accommodate spool motion. This throttling effect generates a pressure differential between V1 and V2 that resists, or dampens, motion of valve spool 1.

When valve spool 1 is shifted away from the motor assembly as illustrated in FIG. 6, in response to increasing translation of power nut 12 and compression of energizing spring 13, land 002 begin restricting the oil flow path between low pressure tank port T and working pressure port W; and with sufficient travel, 001 will permit communication of fluid from high pressure port P to working pressure port W.

In the fully de-energized position of valve spool 1 as shown in FIG. 7, land 001 isolates high pressure port P from working port W, and land 002 permits communication of fluid from working port W to tank port T. The return spring 4 biases the valve in the direction of the motor assembly.

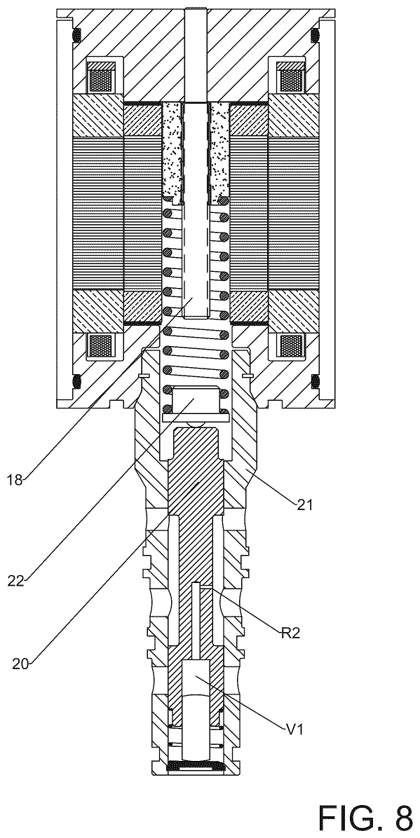

An alternative embodiment of the motorized pressure control valve is illustrated in FIG. 8. This embodiment simplifies the architecture with modifications including valve spool 20, valve body 21, spring pilot 22, and the omission of bias pin 19. Valve spool 20 features 001 and 002 are equivalent diameter and thus pressure balanced. Thus, valve spool 20 reaches equilibrium when energizing spring force driving the valve spool is balanced by the working pressure W imparted upon the bias pin feedback area and force exerted by valve spring 4.

$${F}_{e \cdot spring} - {F}_{v \cdot spring} = {P}_{working} * {Area}_{bias}$$

Oil is communicated between feedback oil volumes V1 and W via restriction R2, formed within the valve spool. This throttling effect generates a backpressure that resists, or dampens, motion of valve spool 20. This embodiment offers manufacturing simplicity at the expense of dynamic performance.

### INDUSTRIAL APPLICABILITY

Numerous modifications to the present disclosure will be apparent to those skilled in the art in view of the foregoing description. Accordingly, this description is to be construed as illustrative only and is presented for the purpose of enabling those skilled in the art to make and use aspects of the disclosure. The exclusive rights to all modifications which come within the scope of the appended claims are reserved.

I claim:

1. An electromechanical device comprising:
a plurality of energizing coils;
an electric motor rotor, wherein a ferromagnetic structure and a non-ferromagnetic bearing element are cohesively integrated into a composite rotor body that features an external bearing surface and is configured to conduct magnetic flux, and further wherein the external mating envelope of said ferromagnetic structure and the external mating envelope of said external bearing surface are precisely coaxial; and
an electric motor stator with a plurality of poles; wherein a ferromagnetic structure and a non-ferromagnetic bearing element are cohesively integrated into a composite stator body that features an internal bearing surface and is configured to conduct magnetic flux, and further wherein the internal mating envelope of said ferromagnetic structure and the internal mating envelope of said internal bearing surface are precisely coaxial,
wherein the stator body operatively receives the rotor body such that stator internal bearing and rotor external bearing cooperatively define a bearing set with a nominal radial clearance that is precisely controlled, and wherein the energizing coils, the stator and the rotor cooperatively define a magnetic circuit, and
wherein a radial flux gap is defined as the radial distance, at any mechanical angle, between the internal mating envelope of the stator ferromagnetic structure and the external mating envelope of the rotor ferromagnetic structure, and wherein during motor operation all radial flux gaps are configured to remain substantially equal, and wherein the nominal radial flux gap is configured to be sufficiently larger than the nominal bearing clearance to maintain balanced magnetic forces despite bearing set eccentricity, and wherein these objectives are achievable by bearing and ferromagnetic structure integration methods as set forth herein, and wherein the nominal radial flux gap is defined as the condition where all material dimensions are of nominal size, and all radial flux gaps are equidistant, and wherein the nominal bearing clearance is the radial clearance defined as the condition where all material dimensions are of nominal size and the rotor and stator bearings are perfectly coaxial.

2. The electromechanical device of claim 1, wherein the rotor includes a thru passage formed therein, the thru passage being configured to receive one or more power transmission elements.

3. The electromechanical device of claim 2, further comprising a housing configured to enclose the stator and rotor, wherein the stator and rotor are operatively disposed within the housing.

4. The electromechanical device of claim 3, wherein the housing comprises:
a motor case;
a drive end (DE) end bell, coupled to a first end of the motor case, wherein the DE end bell includes an opening to permit fluid communication and power transmission from rotor to an external apparatus; and
a non-drive end (NDE) end bell, coupled to a second end of the motor case opposite the first end,
wherein the motor case, DE end bell, and NDE end bell are assembled to form a sealed enclosure, the sealed enclosure defining a fluid volume containing the stator and rotor, and
wherein the fluid volume is configured to receive fluid via the DE end bell opening.

5. The electromechanical device of claim 4, further comprising:
a power screw shaft aligned along a common axis with the stator and rotor, the power screw shaft being fixed against rotation, wherein said power screw shaft includes an external thread profile configured to engage a rotating element to convert rotary motion to linear motion, and wherein said power screw shaft extends into the thru passage feature of the rotor; and
a power nut, wherein said power nut includes an internal thread configured to mesh with the external thread profile of the power screw shaft, and wherein the power nut is fixed against rotation relative to the rotor.

6. The electromechanical device of claim 5, wherein the power nut is operatively disposed within the thru passage of the rotor and configured for axial translation relative to the rotor, wherein the power nut includes an anti-rotation feature on its outer surface, and the thru passage includes a complementary geometry configured to engage the anti-rotation feature to prevent rotation of the power nut relative to the rotor while permitting axial translation, and
wherein the power nut will translate axially along the power screw shaft in response to rotation of the rotor.

7. The electromechanical device of claim 6, further comprising:
an energizing spring operatively coupled to the power nut, wherein the energizing spring is configured to transfer axial displacement of the power nut as an axial force to a work element;
a nut pilot, positioned between the power nut and one end of the energizing spring, wherein said nut pilot includes a planar surface normal to the axis of the power nut, and wherein said pilot nut is configured to axially align and mechanically couple the energizing spring to the power nut;
a thrust bearing, positioned between the planar surface of the nut pilot and the energizing spring, wherein said thrust bearing and said nut pilot are collectively configured to transmit axial displacement from the power nut to the energizing spring while permitting rotational slippage between the power nut and the energizing spring; and
a spring pilot, positioned between the work element and an opposing end of said energizing spring, wherein said spring pilot is configured to transfer axial spring force to said work element while minimizing induced radial forces caused by misalignment.

8. The electromechanical device of claim 7, wherein the rotor includes a first terminal planar surface normal to its axis, and wherein the NDE end bell includes a planar bearing surface, normal to the stator axis as assembled, and configured to bound axial displacement of the rotor in a direction of the NDE end bell.

9. The electromechanical device of claim 8, wherein the rotor has a second terminal planar surface normal to its axis and opposing said first terminal planar surface, and wherein the DE end bell has a planar bearing surface, normal to the stator axis as assembled, and configured to bound axial displacement of the rotor in a direction of the DE end bell.

10. The electromechanical device of claim 9, further comprising:
a first thrust bearing freely disposed between the planar bearing surface of the NDE end bell and the first terminal planar surface of the rotor; and
a second thrust bearing freely disposed between the planar bearing surface of the DE end bell and the second terminal planar surface of the rotor,
wherein said first and second thrust bearings improve rotational mechanical efficiency when the rotor experiences an axial load.

11. The electromechanical device of claim 10, wherein the DE end bell includes features configured to couple with a hydraulic valve body, and wherein the DE end bell opening is configured to receive hydraulic fluid from said hydraulic valve body.

12. The electromechanical device of claim 11, further comprising the hydraulic valve body coupled to the DE end bell and including:
a plurality of apertures to provide for fluid flow;
a first port in fluid communication with a low-pressure reservoir;
a second port in fluid communication with a control volume, wherein pressurized oil in said control volume is conceived to cooperate with an external mechanism configured to produce mechanical work; and
a seal configured to prevent unintended leakage from said hydraulic valve body.

13. The electromechanical device of claim 12, wherein the work element is a fluid metering element received by the hydraulic valve body and movably disposed, and
wherein said fluid metering element defines a variable fluid path between the first port and the second port.

14. The electromechanical device of claim 13, wherein the fluid metering element includes a surface configured to receive a pressure force from the control volume oil, wherein said pressure force opposes the axial energizing spring force.

15. The electromechanical device of claim 1, wherein said electric motor stator and rotor assembly define a switched reluctance motor.

16. The electromechanical device of claim 1, wherein said electric motor stator and rotor assembly define a synchronous reluctance motor.

17. The electromechanical device of claim 1, wherein the internal bearing surface is an interrupted cylinder.

18. The electromechanical device of claim 1, further comprising:
a power screw shaft aligned along a common axis with the stator and rotor, wherein said power screw shaft includes an external thread profile configured to engage a rotating element to convert rotary motion to linear motion; and
a power nut, wherein said power nut includes an internal thread configured to mesh with the external thread profile of the power screw shaft.

19. The electromechanical device of claim 18, wherein the power screw shaft is fixed against rotation and extends into the passage feature of the rotor, and wherein the power nut is fixed against rotation relative to the rotor.

20. The electromechanical device of claim 1, wherein the non-ferromagnetic bearing elements are configured to operate in a hydraulic fluid environment, providing lubrication and thermal management benefits not available in conventional air-cooled motor arrangements.

21. The electromechanical device of claim 1, wherein the nominal radial flux gap is maintained at a ratio of at least 6:1 relative to a nominal radial bearing clearance to ensure balanced magnetic forces despite manufacturing tolerances.

22. The electromechanical device of claim 1, wherein the composite stator body comprises the ferromagnetic structure and bearing element formed as a unitary assembly without intermediate mounting components, and wherein the composite rotor body comprises the ferromagnetic structure and bearing element formed as a unitary assembly without intermediate mounting components.

23. The electromechanical device of claim 1, wherein the bearing surfaces are machined directly into the composite bodies after integration of the ferromagnetic structures.

24. The electromechanical device of claim 1, wherein the ferromagnetic structures comprise laminated steel elements, and wherein the stator bearing surfaces define interrupted cylindrical sections that accommodate coil winding installation.

25. A hydraulic valve comprising:
a hydraulic valve body including:
a plurality of apertures to provide for fluid flow;
a first port in fluid communication with a first hydraulic circuit;
a second port in fluid communication with a second hydraulic circuit; and
a seal configured to prevent unintended leakage from said hydraulic valve body;
a fluid metering element received by the hydraulic valve body and movably disposed, wherein said fluid metering element defines a variable fluid path between the first port and the second port; and
an electromechanical actuator that converts an electrical signal into mechanical force and motion and includes:
a plurality of energizing coils;
an electric motor rotor, wherein a ferromagnetic structure and a non-ferromagnetic bearing element are cohesively integrated into a composite rotor body that features an external bearing surface and is configured to conduct magnetic flux, and further wherein the external mating envelope of said ferromagnetic structure and the external mating envelope of said external bearing surface are precisely coaxial;
an electric motor stator with a plurality of poles; wherein a ferromagnetic structure and a non-ferromagnetic bearing element are cohesively integrated into a composite stator body that features an internal bearing surface and is configured to conduct magnetic flux, and further wherein the internal mating envelope of said ferromagnetic structure and the internal mating envelope of said internal bearing surface are precisely coaxial;
wherein the stator body operatively receives the rotor body such that stator internal bearing and rotor external bearing cooperatively define a bearing set with a nominal radial clearance that is precisely controlled, and wherein the energizing coils, the stator and the rotor cooperatively define a magnetic circuit, and
wherein a radial flux gap is defined as the radial distance, at any mechanical angle, between the internal mating envelope of the stator ferromagnetic structure and the external mating envelope of the rotor ferromagnetic structure, and wherein during motor operation all radial flux gaps are configured to remain substantially equal, and wherein the nominal radial flux gap is configured to be sufficiently larger than the nominal bearing clearance to maintain balanced magnetic forces despite bearing set eccentricity, and wherein these objectives are achievable by bearing and ferromagnetic structure integration methods as set forth herein, and wherein the nominal radial flux gap is defined as the condition where all material dimensions are of nominal size, and all radial flux gaps are equidistant, and wherein the nominal bearing clearance is the radial clearance defined as the condition where all material dimensions are of nominal size and the rotor and stator bearings are perfectly coaxial;
a motor case;
a drive end (DE) end bell, coupled to a first end of the motor case, wherein said DE end bell includes features configured to operatively couple with the hydraulic valve body, and wherein said DE end bell also includes an opening configured to receive fluid from the hydraulic valve body and to permit power transmission from said rotor through a mechanical chain to the fluid metering element; and
a non-drive end (NDE) end bell, coupled to a second end of the motor case opposite the first end,
wherein the motor case, DE end bell, and NDE end bell are assembled to form a sealed enclosure, the sealed enclosure defining a fluid volume containing the stator and rotor, and wherein the fluid volume is configured to receive fluid via the DE end bell opening.

26. The hydraulic valve of claim 25, wherein the rotor includes a thru passage formed therein, the thru passage being configured to receive one or more power transmission elements.

27. The hydraulic valve of claim 26, further comprising:
a power nut operatively disposed within the thru passage of the rotor and fixed against rotation relative to the rotor, wherein said power nut also includes an internal thread configured to mesh with an external thread profile of a power screw shaft, and
wherein the power screw shaft received in part by said power nut and aligned along a common axis with the stator and rotor, wherein said power screw shaft includes an external thread profile configured to engage the power nut.

28. The hydraulic valve of claim 27, wherein the power screw shaft is coupled to the NDE end bell and fixed against rotation,
wherein the power nut includes an anti-rotation feature on its outer surface, and the rotor thru passage includes a complementary geometry configured to engage the anti-rotation feature to prevent rotation of the power nut relative to the rotor while permitting axial translation, and
wherein the power nut will translate axially along the power screw shaft in response to rotation of the rotor.

29. The hydraulic valve of claim 28, further comprising:
an energizing spring operatively coupled to the power nut, wherein the energizing spring is configured to transfer axial displacement of the power nut as an axial force to the fluid metering element;
a nut pilot, positioned between the power nut and one end of the energizing spring, wherein said nut pilot includes a planar surface normal to the axis of the power nut, and wherein said pilot nut is configured to axially align and mechanically couple the energizing spring to the power nut;
a thrust bearing, positioned between the planar surface of the nut pilot and the energizing spring, wherein said thrust bearing and said nut pilot are collectively configured to transmit axial displacement from the power nut to the energizing spring while permitting rotational slippage between the power nut and the energizing spring; and
a spring pilot, positioned between the fluid metering element and an opposing end of said energizing spring, wherein said spring pilot is configured to transfer axial spring force to said fluid metering element while minimizing induced radial forces caused by misalignment.

30. The hydraulic valve of claim 29, wherein said fluid metering element is a hydraulic spool.

31. The hydraulic value of claim 27, wherein the power screw shaft includes a terminal feature configured to operatively engage a complementary feature integral to the fluid metering element, and
wherein the power screw shaft further includes a flexional feature, located between external threads and the terminal feature and configured to provide controlled flexibility under bending moments while maintaining high stiffness in torsion and compression, therein permitting axial misalignment between the power nut and the fluid metering element greater than afforded by part clearances alone.

32. The hydraulic valve of claim 25, wherein the internal stator bearing surface is an interrupted cylinder.
